(19) United States
(12) Patent Application Publication
(10) Pub. No.: US 2015/0003664 A1
(43) Pub. Date: Jan. 1, 2015

(54) MULTI-STRANDED VOICE COIL WIRE

(71) Applicant: Merry Electronics (Suzhou) Co., Ltd., Suzhou City (CN)

(72) Inventors: Jui-Cheng Chang, Suzhou City (CN); Li-Hsin Wu, Suzhou City (CN)

(21) Appl. No.: 13/929,935

(22) Filed: Jun. 28, 2013

(51) Int. Cl. H04R 9/04

(52) U.S. Cl. CPC H04R 9/04
USPC 381/410

(57) ABSTRACT

A multi-stranded voice coil wire includes an elastic body and at least a metal wire. The metal wire is twisted around the elastic body, the metal wire being surrounded by an insulating layer, and the insulating layer being surrounded by an adhesive layer. In the present invention, the elastic body and the metal wire of different materials are stranded together, which makes the present voice coil has smaller height as compared to the convention voice coil has the same resistance and the same configuration size. This makes the present voice coil have more strength and longer lifetime, and helps to design a thinner loudspeaker and increases the heat dissipation efficiency of the voice coil.

### FIELD OF THE INVENTION

The present invention relates to loudspeaker area, and more particularly to a multi-stranded voice coil wire composed by wires of different materials.

### BACKGROUND OF THE INVENTION

During a loudspeaker operates, current of high frequency flows through a voice coil and generates a magnetic field which drives a cone of the loudspeaker to vibrate and therefore produce a sound. FIGS. 1 and 2 show a conventional voice coil wire which includes a single metal wire 1. The metal wire 1 is surrounded by an insulating layer 2 and an adhesive layer 3, which causes the metal wire 1 to be insufficient in heat-resistance. Therefore, when an operating power of the loudspeaker is increased, the metal wire 1 such as aluminum wire and copper wire is easy to broken because of the high temperature. On the other hand, due to the tensile strength of the material of the conventional metal voice wire is insufficient, plus the loudspeaker works under a high operating power for a long time, the voice wire is easy to lack of stress and generates metal fatigue broken. For solving such problems, the general way is to increase the height of coiling width of the voice coil, or to increase the number of the coil turns, but all of these will increase the thickness of the loudspeaker. Therefore, the way to increase coil resistance to limit the power of the loudspeaker reverses the thinner and high power trend of the loudspeaker.

### SUMMARY OF THE INVENTION

The present invention provides a multi-stranded voice coil wire which increases the strength of the voice coil wire.

An embodiment of the present invention provides a multi-stranded voice coil wire includes an elastic body and at least a metal wire. The metal wire is twisted around the elastic body, the metal wire being surrounded by an insulating layer, and the insulating layer being surrounded by an adhesive layer.

In the present invention, the elastic body and the metal wire of different materials are stranded together, which makes the present voice coil has smaller height as compared to the convention voice coil has the same resistance and the same configuration size. This makes the present voice coil have more strength and longer lifetime, and helps to design a thinner loudspeaker and increases the heat dissipation efficiency of the voice coil.

### BRIEF DESCRIPTION OF THE DRAWINGS

The present invention will become more readily apparent to those ordinarily skilled in the art after reviewing the following detailed description and accompanying drawings, in which:

FIG. 1 shows a schematic, three-dimensional view of a conventional voice coil wire.

FIG. 2 shows a schematic, cross-sectional view of the conventional voice coil wire of FIG. 1.

FIG. 3 shows a schematic, three-dimensional view of a multi-stranded voice coil wire according to an embodiment of the present invention.

FIG. 4 shows a schematic, cross-sectional view of the multi-stranded voice coil wire of FIG. 3.

FIG. 5 shows a schematic, three-dimensional view of a multi-stranded voice coil wire according to an embodiment of the present invention.

FIG. 6 shows a schematic, cross-sectional view of the multi-stranded voice coil wire of FIG. 5.

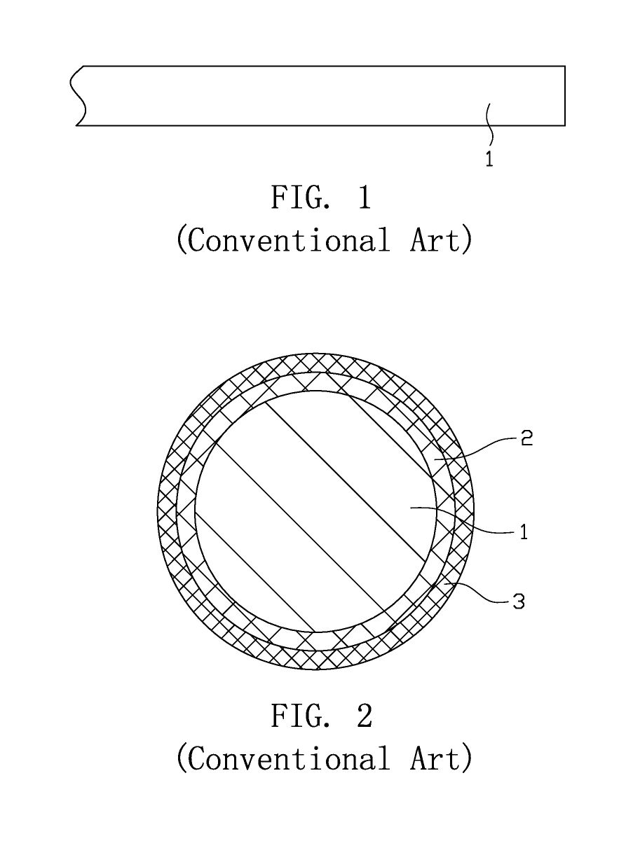

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

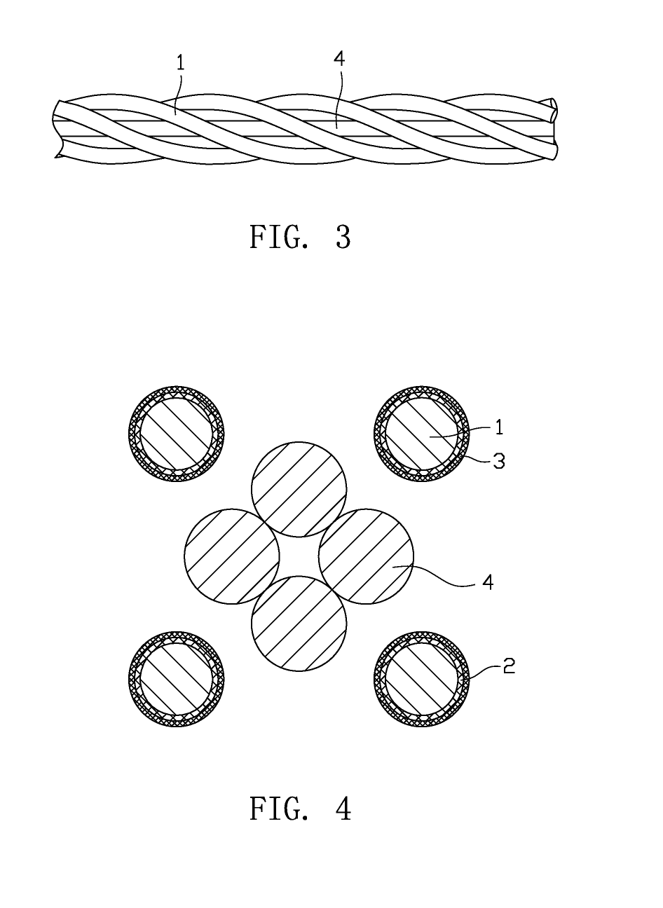

FIG. 3 shows a schematic, three-dimensional view of a multi-stranded voice coil wire according to an embodiment of the present invention. FIG. 4 shows a schematic, cross-sectional view of the multi-stranded voice coil wire of FIG. 3. Referring to FIGS. 3 and 4, the multi-stranded voice coil wire includes an elastic body 4 and at least a metal wire 1. The elastic body 4 includes four parallel polyurethane fibers. The at least a metal wire 1 may be four copper wires in this embodiment. The cooper wires are twisted around the elastic body 4 in a spiral manner. The elastic body 4 is enclosed at a centre of the voice coil wire by the copper wires. The metal wire 1 is surrounded by an insulating layer 2, which is made of heat resistant polyurethane or weldable polyurethane in low temperature. The insulating layer 2 is surrounded by an adhesive layer 3 such as a glue layer for adhering adjacent wires (including the copper wires and the elastic body 4) together. That is, adjacent copper wires, and adjacent cooper wire and elastic body 4 are adhered together by the adhesive layer 3. The adhesive layer 3 may be made of thermoplastic material such as polyvinyl butyral resin or polyamide, or thermosetting material.

Polyurethane fiber is of excellent bending fatigue resistance, excellent heat resistance and excellent chemical resistance. Stranding the polyurethane fibers and the copper wires of different materials together increases the yield strength, the tensile resistance, and the stress and fatigue life of the voice coil wire, which makes the voice coil could bear higher rated power, and accordingly decrease the risk of wire broken.

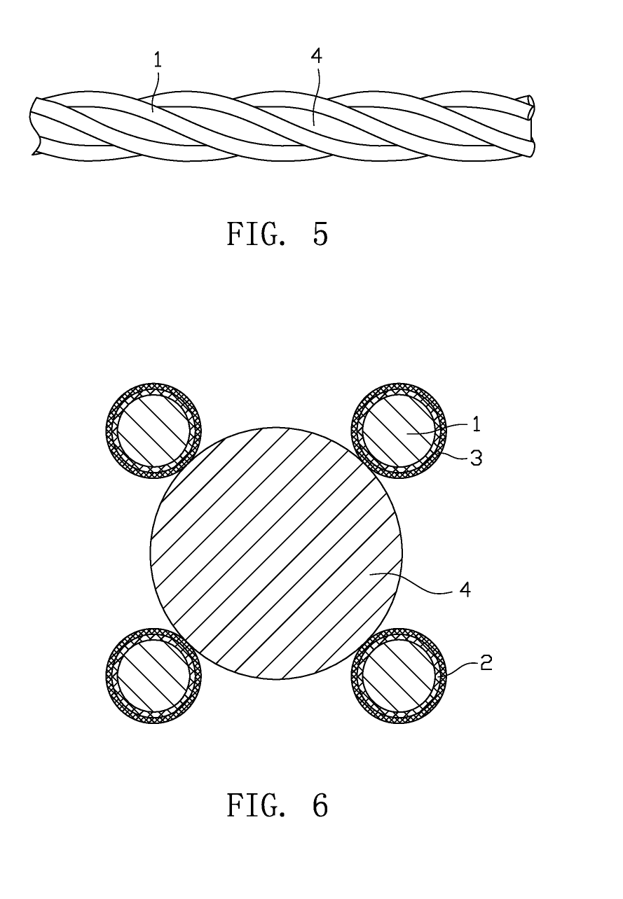

FIG. 5 shows a schematic, three-dimensional view of a multi-stranded voice coil wire according to an embodiment of the present invention. FIG. 6 shows a schematic, cross-sectional view of the multi-stranded voice coil wire of FIG. 5. Referring to FIGS. 5 and 6, the multi-stranded voice coil wire includes an elastic body 4 and at least a metal wire 1 twisted around the elastic body 4 in a spiral manner. The elastic body 4 is an aramid fiber. The at least a metal wire 1 may be four aluminum wires in this embodiment. The elastic body 4 is enclosed at a centre of the voice coil wire by the aluminum wires. The metal wire 1 is surrounded by an insulating layer 2, which is made of heat resistant polyurethane or weldable polyurethane in low temperature. The insulating layer 2 is surrounded by an adhesive layer 3 such as a glue layer for adhering adjacent wires (including the aluminum wires and the elastic body 4) together. The adhesive layer 3 may be made of thermoplastic material such as polyvinyl butyral resin or polyamide, or thermosetting material.

Aramid fiber is made of special synthetic material, in its polymer long chain molecules, aliphatic groups are displaced by amide derivatives. When the chain molecule is arranged in zigzag structure, the aramid fiber is referred to as meta-aramid fiber. The meta-aramid fiber has excellent heat resistance, flame resistance and insulating property. When the chain molecule is arranged in a straight line, the aramid fiber is referred to as para-aramid fiber. The para-aramid fiber has the property of high strength and high rigidity. Stranding the aramid fibers and the aluminum wires of different materials together makes the voice coil could bear higher temperature and greater stress, and accordingly decrease the risk of wire broken.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-stranded voice coil wire comprising:
an elastic body; and
at least a metal wire twisted around the elastic body,
wherein the metal wire being surrounded by an insulating layer, and the insulating layer being surrounded by an adhesive layer.

2. The multi-stranded voice coil wire according to claim 1, wherein each of the metal wires is twisted around the elastic body in a spiral manner.

3. The multi-stranded voice coil wire according to claim 1, wherein the elastic body is enclosed at a centre of the voice coil wire by the at least a metal wire.

4. The multi-stranded voice coil wire according to claim 1, wherein the elastic body comprises at least an elastic fiber.

5. The multi-stranded voice coil wire according to claim 4, wherein the elastic fiber is made of polyurethane fiber or aramid fiber.

6. The multi-stranded voice coil wire according to claim 1, wherein the insulating layer is made of heat resistant polyurethane or weldable polyurethane in low temperature.

7. The multi-stranded voice coil wire according to claim 5, wherein the at least a metal wire is made of cooper wires or aluminum wires.

8. The multi-stranded voice coil wire according to claim 7, wherein the polyurethane fibers and the copper wires are stranding together.

9. The multi-stranded voice coil wire according to claim 7, wherein the aramid fiber and the aluminum wires are stranding together.

10. The multi-stranded voice coil wire according to claim 1, wherein the adhesive layer is a glue layer.

11. The multi-stranded voice coil wire according to claim 10, wherein the glue layer is made of thermoplastic material or thermosetting material.

12. The multi-stranded voice coil wire according to claim 10, wherein the glue layer is made of polyvinyl butyral resin or polyamide.
